(19) United States
(12) Patent Application Publication
(10) Pub. No.: US 2005/0149680 A1
(43) Pub. Date: Jul. 7, 2005

(54) Fast associativity collision array and cascaded priority select

(75) Inventors: Stephan J. Jourdan, Portland, OR (US); Mark C. Davis, Portland, OR (US)

Correspondence Address: KENYON & KENYON, 1500 K STREET, N.W., SUITE 700, WASHINGTON, DC, 20005, US

(73) Assignee: INTEL CORPORATION

(21) Appl. No.: 10/747,144

(22) Filed: Dec. 30, 2003

(51) Int. Cl. G06F 12/00

(52) U.S. Cl. 711/118; 712/225

(57) ABSTRACT

Embodiments of the present invention provide a fast associativity collision array and cascaded priority select. An instruction fetch unit may receive an instruction and may search a primary data array and a collision data array for requested data. The instruction fetch unit may forward the requested data to a next pipeline stage. An instruction execution unit may perform a check to determine if the instruction is valid. If a conflict is detected at the primary data array, an array update unit may update the collision data array.

### TECHNICAL FIELD

The present invention relates to processors. More particularly, the present invention relates to processing data in an instruction pipeline of a processor.

### BACKGROUND OF THE INVENTION

Many processors, such as a microprocessor found in a computer, use an instruction pipeline to speed the processing of instructions. Pipelined machines fetch the next instruction before they have completely executed the previous instruction. If the previous instruction was a branch instruction, then the next-instruction fetch could have been from the wrong place. Branch prediction is a known technique employed by a branch prediction unit (BPU) that attempts to infer the proper next instruction address to be fetched. The BPU may predict taken branches and corresponding targets, and may redirect an instruction fetch unit (IFU) to a new instruction stream. The IFU may fetch data associated with the predicted instruction from arrays included in a memory or cache.

In high-frequency processors, arrays can take several cycles to access. This increased access time can lead to significant performance degradation when latency becomes relevant. In order to minimize the access time of critical latency-sensitive arrays, conventional techniques remove the associativity and the corresponding tag compare logic from the array. However, the removal of associativity can cause performance degradation due to conflict aliasing, for example.

### BRIEF DESCRIPTION OF THE DRAWINGS

Embodiments of the present invention are illustrated by way of example, and not limitation, in the accompanying figures in which like references denote similar elements, and in which:

FIG. 1 is a block diagram of a processor in accordance with an embodiment of the present invention;

FIG. 2 illustrates a detailed block diagram of a processor pipeline in accordance with an embodiment of the present invention;

FIG. 3 is a flow chart illustrating a method in accordance with an embodiment of the present invention;

FIG. 4 is a system block diagram in accordance with an embodiment of the present invention; and

FIG. 5 is a diagram illustrating array operation in accordance with an embodiment of the present invention.

### DETAILED DESCRIPTION

Embodiments of the present invention provide a fast collision array in addition to a primary array. The collision array may be a non-symmetrical tagged array. When a prediction is made, a speculative array access may check the primary array as well as the collision array for the desired data. If the collision array hits, data may be retrieved from the collision array and transmitted to a data consumer such as the next stage in an instruction pipeline. At a later stage in the pipeline, a data check may determine whether the data from the collision array was correct or whether there was a misprediction. If there was a misprediction, the collision array as well as the primary array may be updated, in accordance with embodiments of the present invention. Hysteresis bits and/or tag bits may be used to update and/or manage the collision array as well as the primary array.

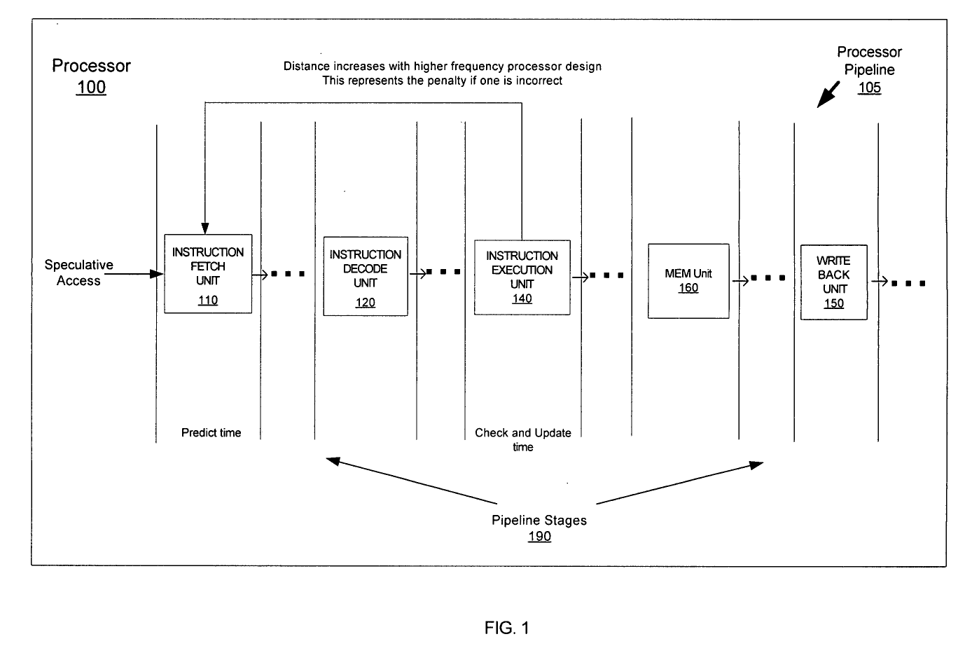

FIG. 1 is a simplified block diagram of a processor 100 including an example of a processor pipeline 105 in which embodiments of the present invention may find application. The processor pipeline 105 may include a plurality of pipeline stages 190. As shown in FIG. 1, the processor pipeline 105 may include a plurality of components that may be located at the various pipeline stages. The processor pipeline may include, for example, an instruction fetch unit (IFU) 110, an instruction decode unit 120, instruction execution unit 140, a memory (MEM) unit 160 and write back unit 150. Although five units are shown, it is recognized that a processor pipeline can include any number of units or pipeline stages.

In embodiments of the present invention, the IFU 110 may fetch instruction byte(s) from memory and place them in a buffer until the bytes are needed. The instruction decode unit 120 may fetch and decode the instruction by determining the instruction type and/or fetch the operands that are needed by the instruction. The operands may be fetched from the registers or from memory. The instruction execution unit 140 may execute the instruction using the operands. The MEM unit 160 may store the operands and/or other data and the write back unit 150 may write the result back to the proper registers.

It should be recognized that the block configuration shown in FIG. 1 and the corresponding description is given by way of example only and for the purpose of explanation in reference to the present invention. It is recognized that the processor 100 may be configured in different ways and/or may include other components. It is recognized that the processor pipeline 105 may include additional stages that are omitted for simplicity.

In embodiments of the present invention, the IFU 110 may include one or more arrays including a non-symmetrical tagged collision array. The collision array may be used in conjunction with a primary array to reduce or eliminate collisions and permit fast and efficient access (to be described below in more detail).

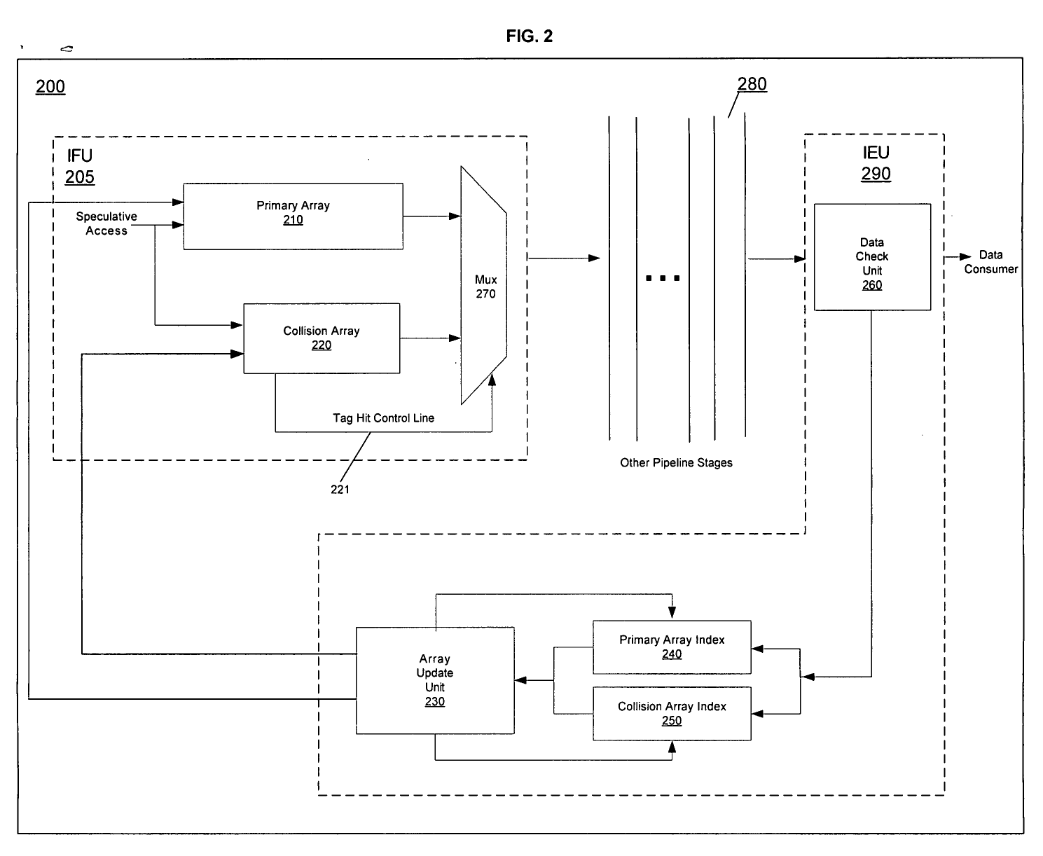

FIG. 2 is a detailed block diagram of a portion of a processor pipeline 200 in accordance with embodiments of the present invention. The processor pipeline may include an instruction fetch unit (IFU) 205, instruction execution unit 140 as well as other stages 280. It is recognized that processor pipeline 200 may include additional components and/or stages, details for which are omitted for simplicity.

As described above, instruction pipelines may be used to speed the processing of instructions in a processor by increasing instruction throughput. Pipelined machines may fetch the next instruction before a previous instruction has been fully executed. In this case, a branch instruction may be predicted to be taken and the IFU 205 may perform a speculative access of an array to retrieve the associated data. The retrieved data may be forwarded to the other stages of the processor pipeline 280 for processing. In embodiments of the present invention, the instruction execution unit 290 may execute the data and determine whether the branch was predicted correctly or whether there was a misprediction. If there was a misprediction, the instruction execution unit (IEU) 290 may update the IFU 205 in accordance with embodiments of the present invention.

It is recognized that, in an embodiment of the invention, IFU 110, shown in FIG. 1, may include the features and/or components of IFU 205, shown in FIG. 2. Moreover, in an embodiment, IEU 140, shown in FIG. 1, may include the features and/or components of IEU 290, shown in FIG. 2.

In an embodiment of the present invention, the IFU 205 may include a primary array 210, a collision array 220 and multiplexer (mux) 270. It is recognized that IFU 205 may include additional components that have been omitted for simplicity. The primary array 210 may be, for example, a direct mapped bi-modal array which may be, for example, 8, 16, 32, 64, 128, 256 or more bits wide and/or may contain 32, 64, 128, 256, or more entries. Direct mapped arrays are needed for higher frequency processor design as tag match logic adds too much latency to the array read time. The collision array 220 may be a non-symmetrical tagged array. The collision array 220 may have lower latency than the primary array 210 and may be smaller in size. The primary array 210 and the collision array 220 may be coupled to and/or provide inputs to mux 270. The output of the mux 270 may be controlled by a tag hit control line 221 from collision array 220. The output of the mux 270 may be coupled to other pipeline stages 280, as shown.

In embodiments of the present invention, it is recognized that other stages of the pipeline such as IDU 120, IEU 140, MEM unit 160, WBU 150, etc. may include the primary array 210 and collision arrays 220, as described herein. It is further recognized that although two arrays are shown in the figures, the IFU 205 and/or any other component may include additional arrays that may operate in accordance with embodiments of the present invention.

In embodiments of the present invention, the other pipeline stages 280 may include other components such as instruction decode and/or other units or components. The output of stages 280 may be processed by the IEU 290, in accordance with embodiments of the present invention. Pipeline stages 280 represent a variable number of stages which may lie between IFU 205 and IEU 290. As processor frequency is increased, the number of stages 280 may increase. This increasing prediction resolution time will cause increasing penalty when speculation is incorrect.

The IEU 290 may include a data check unit 260 which may be coupled to a primary array index 240 and/or a collision array index 250. The primary array index 240 and the collision array index 250 may be coupled to array update unit 230 which may be further coupled to the primary array 210 and the collision array 220 of the IFU 205. It is recognized that primary array index 240, collision array index 250, and/or array update unit may be located internal to or external to the IEU 290.

In embodiments of the present invention, a speculative array access may check primary array 210 and/or collision array 220 for data. The array content is speculative since it is based on, for example, a speculative prediction that a branch is predicted to be taken. If the speculative array access misses the collision array 220, the tag hit control line 221 selects the data from the primary array 210. The primary array 210 hits by definition since it is organized as a direct mapped array for speed. A direct mapped array always hits and tagged arrays are tagged to override the default, direct-mapped prediction from the primary array. The primary array may be tagged at update time to determine a “true hit” in the array. If the speculative access misses the collision array 220, the mux 270 outputs the data from the primary array 210. The data may be processed by pipeline 280 and forwarded to IEU 290 for processing. The data check unit 260 may process the data and determine whether the speculative prediction was correctly predicted. If the branch was predicted correctly, the execution unit may continue to process the next instruction.

If, however, the branch was mispredicted, then the pipeline stages with incorrect speculative data from IFU (e.g., 110 or 205) to IEU (e.g., 140 to 290) may be flushed. All instructions or micro-ops (uops) younger than the mispredicting branch should be flushed from the processor pipeline 200, for example, from IFU 205 to IEU 290.

In embodiments of the present invention, if the speculative array access hits the collision array 220, the tag hit control line 221 may select the data from the collision array and the mux 270 will output the data from the collision array 220. The data may be processed by pipeline 280 and forwarded to IEU 290 for processing. The data check unit 260 may process the data and determine whether the branch instruction was correctly predicted. Although the invention is explained with reference to branch prediction, embodiments of the present invention may be applied to all types of processes that use speculation and/or make predictions.

In embodiments of the present invention, the tag bits and the hysteresis bits in the primary array index 240 and the collision array index 250 may be updated as appropriate (to be discussed below in more detail). If the branch was predicted correctly, the execution unit may continue to process the next instructions.

If, however, the branch was mispredicted, then pipeline stages between IFU (e.g., IFU 110, 205) and IEU (e.g., 140 to 290) may be flushed. All younger instructions or uops are removed from the pipeline during the misprediction. In embodiments of the present invention, the array update unit 230 may update the collision array 220 and the primary array 210.

In embodiments of the present invention, a cascaded priority technique may be used to select between primary array 210 and the collision array 220. When a request for data is received, the collision array 220 may override primary array 210. If the collision array 220 hits, this means that that there was a conflict in the past and the value in the collision array 220 should be preferred over the value in the primary array 210.

In embodiments of the present invention, the primary array index 240 and the collision array index 250 may maintain counters such as a hysteresis counter to update and/or manage the primary array 210 and/or the collision array 220, respectively. The hysteresis counters may be used to control updates to the arrays 210 and/or 220. Hysteresis is a general term to describe a counter. In one example, a 2-bit counter which has the states 0, 1, 2, 3 may be used. The hysteresis counter may gate replacement into the arrays when set to certain states, for example, at state 0, in one embodiment of the present invention. It is recognized that another type of counter such as one with 3 or more bits and the associated additional states may be used in embodiments of the present invention. Such counters may be used to prevent collisions in the arrays such as arrays 210 and/or 220.

In the collision management scheme of the present invention, a direct-mapped original array such as primary array 210 and a set associative, smaller second array such as the collision array 220 are provided to reduce latency as compared to conventional techniques at predict time. During update, both arrays may be tagged to detect true hit. In one embodiment of the present invention, the update on tag hit is not gated by hysteresis. The hysteresis counters (e.g., maintained by the primary array index 240 and/or collision array index 250) may still be updated without a tag hit. This allows conflicting instructions to influence the bias of the hysteresis counter when they are thrashing each other. For example, thrashing may occur when frequently used cache lines replace each other. This can occur, for example, if there is a conflict, too many variables or too large of arrays are accessed that do not fit into cache and/or if there is indirect addressing.

In embodiments of the present invention, the hysteresis counter may be incremented and/or decremented based on the contents of the array it is associated with and the outcome of the prediction. For example, the hysteresis counter may be decremented if there is a misprediction and incremented if the prediction is correct.

In embodiments of the present invention, if the prediction is incorrect (i.e., a misprediction), a check is made to determine if any of the arrays such as primary array 210 and/or collision array 220 hit. It is recognized that a direct mapped bimodal array may have tags at update time which indicate a true hit. If all arrays are missed, the hysteresis counter on both arrays may be read simultaneously. If the counters are set to 0, the arrays may be updated. If the counters are not set to 0, the counters may be decremented. If one or more arrays hit, those one or more arrays may be updated, in accordance with embodiments of the present invention. Array update may include tag updates at both read and update time, counter updates, and/or special hysteresis initialization on allocate.

If the prediction is correct, the corresponding hysteresis counter may be incremented in cascaded priority order. First, the collision array 220 may be checked for a hit and if the collision array hits, the corresponding counter may be incremented. If the collision array 220 misses, the primary array may be checked for a true hit. If a true hit is detected on the primary array 210, the primary array 210 may be updated. In embodiments of the present invention, the primary array may be updated if the collision array 220 misses.

In embodiments of the present invention, the primary array index 240 may maintain a first hysteresis counter associated with, for example, the primary array 210 and the collision array index 250 may maintain a second hysteresis counter associated with, for example, the collision array 220.

In accordance with embodiments of the present invention, the first hysteresis counter associated with the primary array 210 may be initialized to 0 while the second hysteresis counter may be initialized to 1 on allocate. If a conflict is detected, primary array 210 and collision array 220 will be updated. By setting the primary array hysteresis counter to 0 and the collision array to 1, replacement of both values in both arrays may be avoided and only the colliding instruction may be allocated solely into the collision array 220.

In embodiments of the invention, if there is a hit and the prediction is correct, the hysteresis counter associated with the array with highest priority may be incremented. For example, if the collision array 220 has precedence and/or hits, the counter associated with collision array 220 may be incremented. If arrays 210 and 220 are hit and the prediction is correct, the primary array 210 is not updated. If the collision array 220 is missed, but the primary array 210 hits, the primary array 210 may be updated. In order to fully utilize arrays 210 and 220, each data item may be stored in a single array, where possible, in accordance with embodiments of the present invention. Thus only conflicting data may be stored in the second array such as the collision array 220. It is recognized that if the number of collisions is larger than the number of collision arrays, thrashing may still occur.

In embodiments of the present invention, if however, there is a hit on either bimodal array (e.g., array 210 and 220) but there was a misprediction, the array that was hit may be updated. In this case, the associated hysteresis counter may be examined. If the counter is 0, the entry associated with the counter with the correct prediction and tags corresponding to the correct prediction may be updated. The hysteresis counter is incremented when either array 210 or array 220 is updated, promoting the counter value to 1 in both cases. It is recognized that both bimodal arrays 210 and 220 may hit and both arrays 210 and 220 may be updated independently on a misprediction. A hit may be detected on the direct-mapped primary array with a special tag on the update path. This tag stores the upper bits of the address. When the updating instruction matches the address of the tags stored in the array, this means that a true hit is detected. If the tags of the updating instruction do not match the tags stored in the array, a miss occurs. The collision array 220 has tags at both predict and update time, which may or may not be the same set of tags.

In embodiments of the present invention, if the speculative access misses both arrays 210 and 220, it is assumed that thrashing has occurred. In this situation, both arrays may be updated. If the hysteresis counters associated with both arrays are 0, then both arrays may be allocated. Upon allocation, the data, tags and/or hysteresis counters of the updated array may be modified. The primary and/or collision array hysteresis counter will be incremented to 1 on update. If the hysteresis counter is non-zero (e.g., counter value=1), the corresponding counter may be decremented, but array update may not occur.

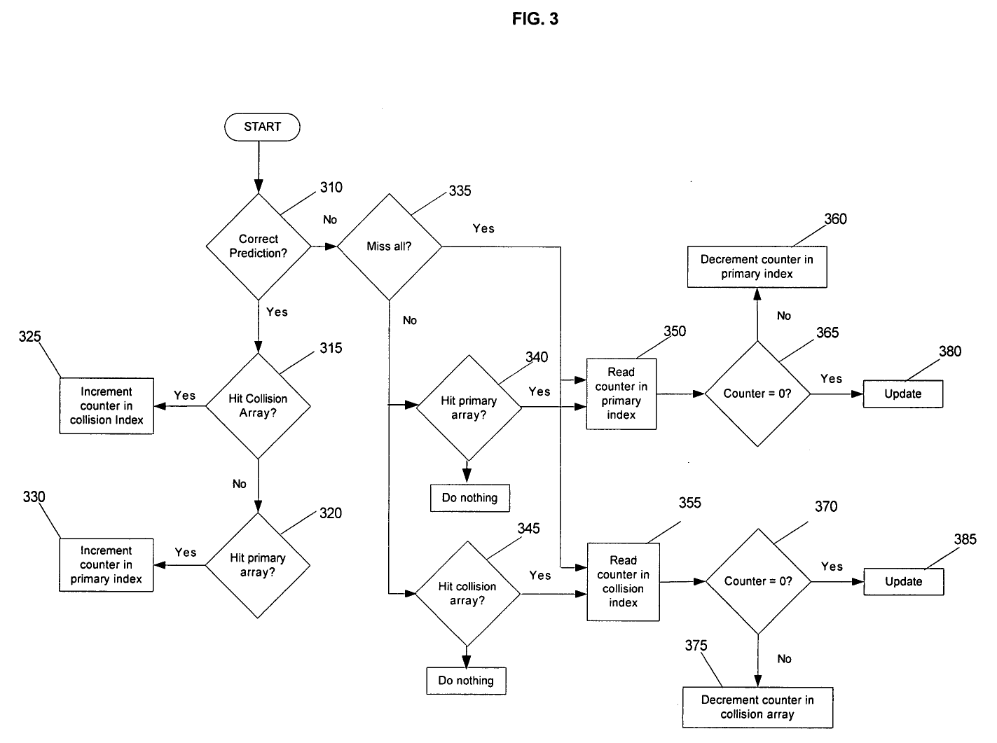

FIG. 3 is a flowchart illustrating a method in accordance with an embodiment of the present invention. In embodiments of the present invention, hysteresis counters such as the first counter (e.g., primary counter) implemented in primary array index 240 and a second counter (e.g., collision counter) implemented in collision array index 250 may be used to gate the update of contents to the primary array 210 and collision array 220, respectively. In embodiments of the present invention, predictors in IFU 110 or IFU 205 are read at predict time to generate predictions. If the data check unit determines that a branch prediction was correct and there was a hit in one of the arrays such as collision array 220, the corresponding counter in collision index such as index 250 may be incremented, as shown in boxes 310, 315 and 325. If the prediction was correct, but the collision array was missed and primary array such as array 210 was hit, then the corresponding counter in primary index such as index 240 may be incremented, as shown in boxes 310, 320 and 330. It is recognized that embodiments of the present may include a tagless bimodal array which always hits at predict time.

If, on the other hand, the prediction was incorrect and a conflict was detected where both arrays such as primary array 210 and collision array 220 were missed, then the counter in the primary and collision indexes may be read, as shown in boxes 310, 335, 350 and 355. As shown in boxes 350, 365 and 380, if the counter in the primary index 240 is read and the counter value is 0, the primary array may be updated. If, however the counter in the primary index 240 is not equal to 0, then the counter in the primary index 240 may be decremented, as shown in boxes 365 and 360. As shown in boxes 355, 370 and 385, if the counter in the collision index 250 is read and the counter value is 0, then the collision array may be updated. If, however, the counter in the collision index 250 is not equal to 0, then the counter in the collision index 250 may be decremented, as shown in boxes 370 and 375.

If, however, the prediction was incorrect but either one or both arrays such as primary array 210 and/or collision array 220 hit, then the corresponding counters in the primary and/or collision indexes may be read, as shown in boxes 310, 335, 340, 350, 345 and 355.

If the primary array hits, the counter in the primary index 240 may be read, as shown in boxes 340 and 350. If the value of the counter in the primary index 240 is 0, then update will occur, as shown in boxes 365 and 380. In this case, the primary array such as array 210 may be updated. If, however, the hysteresis counter in the primary index 240 is not equal to 0, then the counter in the primary index 240 may be decremented, as shown in boxes 365 and 360.

If the collision array hits, the counter in the collision index 250 may be read, as shown in boxes 345 and 355. If the value of the counter in the collision index 250 is 0, the array may be updated, as shown in boxes 370 and 385. In this case the collision array may be updated. If, however, the hysteresis counter in the collision index 250 is not equal to 0, then the counter in the collision index 250 may be decremented, as shown in boxes 370 and 375.

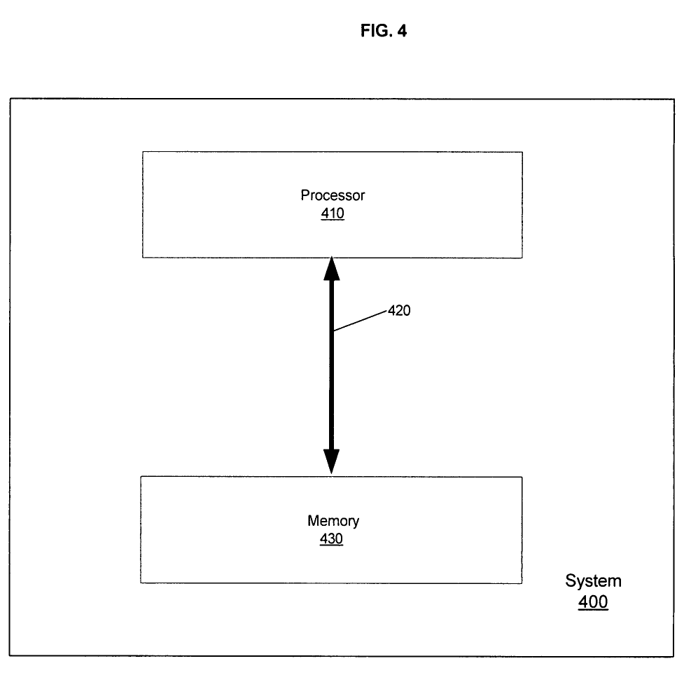

FIG. 4 shows a computer system 400 in accordance with embodiments of the present invention. The system 400 may include, among other components, a processor 410, a memory 430 and a bus 420 coupling the processor 410 to the memory 430.

In embodiments of the present invention, the processor 410 in system 400 may incorporate the functionality as described above. For example, processor 410 may include the instruction pipelines shown in FIGS. 1 and/or 2. It is recognized that the processor 410 may include any variation of the systems and/or components described herein that are within the scope of the present invention.

In embodiments of the present invention, the memory 430 may store data and/or instructions that may be processed by processor 410. In operation, for example, components in the processor 410 may request data and/or instructions stored in memory 430. Accordingly, the processor may post a request for the data on the bus 420. Bus 420 may be any type of communications bus that may be used to transfer data and/or instructions. In response to the posted request, the memory 430 may post the requested data and/or instructions on the bus 420. The processor may read the requested data from the bus 420 and process it as needed.

In embodiments of the present invention, the processor 410 may include an instruction fetch unit such as the IFU 110 and/or IFU 205. Moreover, processor 410 may include an instruction execution unit such as IEU 140 and/or IEU 290. It is recognized that processor 410 may further include additional components, other instruction pipelines, etc. that may or may not be described herein.

In an embodiment of the present invention, the instruction fetch unit such as IFU 205 may receive an instruction. This instruction may be one of the plurality of instructions that are stored in memory 430. The IFU may search a primary data array such as array 210 and a collision data array such as array 220 for the requested data and if the request hits the collision data array, the IFU may forward the requested data from the collision array to a next pipeline stage. The next pipeline stage may be any of stages in the processor pipeline included in the processor 410. For example, the pipeline stages shown in FIG. 1 and/or any of the stages such as stages 280 or IEU 290 could follow the IFU. In a following stage, the instruction execution unit such as IEU 290, may perform a data check 260 to determine if the requested data from the collision array is valid. The requested data is valid, for example, if the prediction was correct. An array update unit such as update unit 230 may update the primary or collision data arrays, if the requested data is not valid. The requested data is not valid if, for example, there was a misprediction.

In an embodiment of the present invention, a speculative update may be eliminated by moving the data check state to the retirement stage. However, this can further delay branch resolution.

It is recognized that the processor 410 may include one or more counters such as a primary counter that may be managed at the primary array index such as index 240 and a collision counter that may be managed at a collision array index such as index 250, in accordance with embodiments of the present. These counters may be used to update and/or manage the primary array 210 and the collision array 220, respectively.

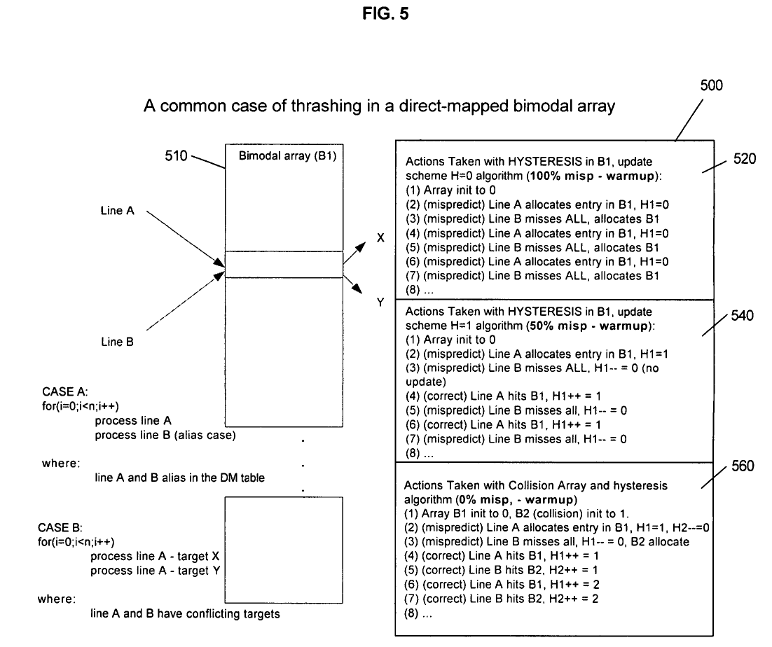

FIG. 5 illustrates an example of three schemes as shown in table 500. The method described in section 560 of table 500 is in accordance with embodiments of the present invention. The method described in sections 520 and 540 describe best-known behavior with hysteresis counters, but no collision array. In the situation described in section 520, a 100% post-warmup misprediction rate is shown due to thrashing of the arrays. The thrash process may continue because all of the hysteresis counters are initialized to 0. The scheme described in section 540 shows that by initializing the hysteresis of the primary array to 1, the post-warmup misprediction rate may be reduced to 50%. The situation described in section 560 illustrates the behavior of the cascaded collision array, in accordance with embodiments of the present invention. Note that a 0% post-warmup misprediction rate may be achieved by using the collision array for the thrashing line B, in accordance with the embodiments of the present invention. As can be seen, the hysteresis counters of both arrays begin to elevate, indicating a highly confident prediction.

Referring again to table 500 of FIG. 5, section 520 shows the alias/conflict/thrashing case where, in one application, two branch instructions continually fight for one table entry. In doing so, the branches are continually mispredicted and overall prediction rate is just 0%.

Section 540 in table 500, shows the improvement by using hysteresis intelligently. The hysteresis bit is able to ignore one of the two aliasing branches in this application and is able to eventually achieve a 50% prediction rate in steady state program execution following array warm-up, in accordance with an embodiment of the present invention.

Section 560 illustrates the ability to attain a 100% correct prediction rate in the presence of two colliding or aliasing lines or branches following array allocation and warm-up, in accordance with an embodiment of the present invention. Embodiments of the invention may achieve performance comparable to a 2-way set associative array without the complexity or latency associated with associative structures.

In an embodiment of the present invention, as indicated at section 560 (1), arrays hysteresis counter is initialized to 0 for bimodal array 1 (e.g., array 510) and 1 for collision array. At section 560 (2), a branch instruction (e.g., line A) or line begins execution in processor 100 at IFU 110. Units in IFU 205 are accessed. Collision array 220 misses and mux 270 forwards the non-tagged prediction from prediction array 210. The prediction feeds pipeline 280 and instruction decode 120 speculatively. During instruction execution at IEU 140 and IEU 290, the branch instruction is resolved in IEU 260 and determined that it was incorrectly predicted at box 310, FIG. 3. The primary array index 240 is accessed and it is determined that it was a true miss (e.g., the tag stored at update did not match the tag of the IP of the instruction). The collision array index 250 is accessed and it is determined that it too was a true miss. It is noted that a read/modify/write at update time is performed to detect aliasing of the counters between predict and update.

In an embodiment of the present invention, as shown in box 335, FIG. 3, it is determined that both arrays are missed (i.e., “miss all”). The hysteresis counters are read (boxes 350, 355) from primary array index 240 and it is determined that it is 0 for the bimodal array (box 365) and 1 (box 370) for the collision array. In this case, the entry in the bimodal array can be replaced (box 380) and the value of the collision array is decremented by 1 (box 375) to 0. The next update to the collision array allows replacement. As a result, in array update unit 230 the instruction entry is allocated into bimodal array 1 510, primary array 210 and the hysteresis counter is initialized to 1.

In an embodiment of the present invention, as indicated at section 560 (3), another branch (e.g., line B) conflicting with the table entry for line A enters processor 100 and IFU 110. IFU 205 arrays are accessed. Collision array 220 misses and mux 270 forwards the non-tagged prediction from prediction array 210. The prediction feeds pipeline 280 and IDU 120 speculatively. During instruction execution at IEU 140 and IEU 290, the branch instruction is resolved in IEU 260 and it is determined that it was incorrectly predicted at 310. The primary array index 240 is accessed and a true miss is determined (the tag stored at update (line A) did not match the tag of the IP of the instruction (line B)). The collision array index 250 is accessed and it is determined that there was a true miss. It is noted that a read/modify/write is performed at update time to detect aliasing of the counters between predict and update. Moreover, the array hit/miss determination compares the full tag, while the hysteresis array read is tagless. As shown in box 335, FIG. 3, it is determined that both arrays are missed (i.e., “miss all”). The hysteresis counters are read (boxes 350 and 355) from primary array index 240 and it is determined that it is 1 for the bimodal array (box 365) and 0 (box 370) for the collision array. In this case, the entry in the collision array may be replaced (box 385) and the value of the bimodal array can be decremented by 1 (box 360) to 0. As a result, in array update unit 230, the instruction entry is allocated into collision Array 1 220 and the hysteresis counter is initialized to 1.

As indicated at section 560 (4), line A hits primary array 510 and 210 in processor 100 at IFU 110 and 205. The prediction feeds pipeline 280 and instruction decode 120 speculatively. During instruction execution at IEU 140 and IEU 290, the branch instruction is resolved in IEU 260 and it is determined that it was correctly predicted at 310. The collision array is missed (box 315), a true hit is detected in the primary array 320 and 230 and the hysteresis counter is incremented (box 330) to 1. Thus, confidence is gained in this prediction.

As indicated at section 560 (5), line B hits collision array 220 in IFU 205/110 in processor 100. The prediction feeds pipeline 280 and instruction decode 120 speculatively. During instruction execution at IEU 140 and IEU 290, the branch instruction is resolved in IEU 260 and it is determined that it was correctly predicted at 310. The collision array hits (box 315), and hysteresis counter is incremented (box 315) to 1. Thus, confidence in gained in this prediction as well.

As indicated at section 560 (6), line A correctly predicts again and confidence builds to 2. As indicated at section 560 (7), line B correctly predicts again and confidence builds to 2.

Embodiments of the present invention provide a collision array with a cascaded priority select. In an embodiment of the invention, the invention achieves 2-way set associativity without the timing cost of tag comparison for 2-way set associativity or full CAM (content-addressable memory) match for a fully associative victim cache. Fast associativity enhances performance in high frequency processors. An instruction fetch unit may receive a speculative instruction and may search a primary data array and a collision data array for requested data. The primary array may be direct mapped to minimize array access time and to maximize array capacity. The collision array is much smaller and is tagged. The collision array is only allocated when thrashing is detected. If the request hits the collision data array, the instruction fetch unit may forward the requested data from the collision array to a next pipeline stage. The default prediction comes from the primary bimodal array and is forwarded on collision array miss. Update is managed with intelligent use of update path tags for both arrays and hysteresis counters.

Several embodiments of the present invention are specifically illustrated and/or described herein. However, it will be appreciated that modifications and variations of the present invention are covered by the above teachings and within the purview of the appended claims without departing from the spirit and intended scope of the invention.

1. A processor, comprising:
an instruction fetch unit to receive an instruction, to search a primary data array and a collision data array for requested data, and to forward the requested data to a next pipeline stage;
an instruction execution unit to perform a check to determine if the instruction is valid; and
an array update unit to update the collision data array if a conflict is detected at the primary data array.

2. The processor of claim 1, wherein the instruction fetch unit is to search the collision array for the requested data and if the collision array hits, the instruction fetch unit is to forward the requested data from the collision array to the next pipeline stage.

3. The processor of claim 2, wherein if the collision array misses, the instruction fetch unit is to forward the requested data to the next pipeline stage from the primary array.

4. The processor of claim 1, further comprising:
one or more pipeline stages coupled to the instruction fetch unit and the instruction execution unit, wherein the one or more pipeline stages are to be flushed if the requested data is not valid.

5. The processor of claim 1, further comprising:
a collision counter coupled to the collision array, wherein if the requested data is valid and if the request hits the collision array, the collision counter is incremented.

6. The processor of claim 1, further comprising:
a primary counter coupled to the primary array, wherein if the requested data is valid and if the request misses the collision array and hits the primary array, the primary counter is incremented.

7. The processor of claim 1, further comprising:
a collision counter coupled to the collision array, wherein if the instruction is mispredicted and request misses the collision array, the collision counter is decremented if the collision counter is not equal to zero.

8. The processor of claim 1, further comprising:
a primary counter coupled to the primary array, wherein if the instruction is mispredicted and the request misses the primary array, the primary counter is decremented if the primary counter is not equal to zero.

9. The processor of claim 1, further comprising:
a multiplexer coupled to the collision data array and the primary data array, wherein the multiplexer is to select an output including the requested data from the primary data array, if the request misses the collision data array.

10. The processor of claim 1, wherein the primary data array is a tag-less direct mapped data array at predict time.

11. The processor of claim 1, wherein the primary data array is a direct mapped tagged array at update time.

12. The processor of claim 1, wherein the collision array is a tagged array at update time.

13. The processor of claim 1, wherein the collision array is a tagged array at predict time.

14. A method comprising:
receiving a speculative request for access to data;
searching a primary data array and a collision data array for the requested data;
forwarding the requested data to one of a plurality of stages if the requested data is found;
performing a data check at one of the plurality of stages to determine if the requested data is valid; and
updating the collision data array if a conflict is detected at the primary data array.

15. The method of claim 14, further comprising:
if the collision array hits, forwarding the requested data from the collision array to the one of the plurality of stages.

16. The method of claim 14, further comprising:
if the collision array misses, forwarding the requested data from the primary array to the one of the plurality of stages.

17. The method of claim 14, further comprising:
flushing one or more stages in the plurality of stages if the requested data is not valid.

18. The method of claim 14, further comprising:
incrementing a collision counter if the requested data is valid and the request hits the collision array.

19. The method of claim 14, further comprising:
incrementing a primary counter if the requested data is valid and the request hits the primary array and misses the collision array.

20. The method of claim 14, further comprising:
updating a primary array if the request is mispredicted, hits the primary array and the primary counter is equal to zero.

21. The method of claim 14, further comprising:
updating a primary array if the request is mispredicted, misses all arrays and the primary counter is equal to zero.

22. The method of claim 14, further comprising:
decrementing a collision counter if the request is mispredicted, hits the collision array and the collision counter is not equal to zero.

23. The method of claim 14, further comprising:
decrementing a collision counter if the request is mispredicted, misses all arrays and the collision counter is not equal to zero.

24. The method of claim 14, further comprising:
updating a collision array if the request is mispredicted, hits the collision array and the collision counter is equal to zero.

25. The method of claim 14, further comprising:
updating a collision array if the request is mispredicted, misses all arrays and the collision counter is equal to zero.

26. A system comprising:
a bus;
an external memory coupled to the bus, wherein the external memory is to store a plurality of instructions; and
a processor coupled to the memory via the bus, the processor including:
an instruction fetch unit to receive a speculative instruction from the plurality of instructions, to search a primary data array and a collision data array for requested data, and the instruction fetch unit to forward the requested data to a next pipeline stage if the data is found;
an instruction execution unit to perform a data check to determine if the requested data is valid; and
an array update unit to update the collision data array, if a conflict is detected at the primary data array.

27. The system of claim 26, wherein the instruction fetch unit is to search the collision array for the data and if the collision array hits, the instruction fetch unit is to forward the requested data from the collision array to the next pipeline stage.

28. The system of claim 26, wherein if the collision array misses, the instruction fetch unit is to forward the requested data to the next pipeline stage from the primary array.

29. The system of claim 26, wherein the processor further comprising:
one or more pipeline stages coupled to the instruction fetch unit and the instruction execution unit, wherein the one or more pipeline stages are to be flushed if the requested data is mispredicted.

30. The system of claim 26, wherein the processor further comprising:
a collision counter coupled to the collision array, wherein if the requested data is predicted correctly and if the request hits the collision array, the collision counter is incremented.

31. The system of claim 26, wherein the processor further comprising:
a collision counter coupled to the collision array, wherein if the request is mispredicted, hits the collision array, the collision counter is decremented if the collision counter is not equal to zero.

32. The system of claim 26, wherein the processor further comprising:
a primary counter coupled to the primary array, wherein if the request is mispredicted, hits the primary array, the primary counter is decremented if the primary counter is not equal to zero.
